(19) United States
(12) Patent Application Publication
(10) Pub. No.: US 2022/0138669 A1
(43) Pub. Date: May 5, 2022

(54) COMMUNICATION SYSTEM FOR MANAGING DISTRIBUTION OF PRODUCTS AND A METHOD THEREOF

(71) Applicant: Effectus Partners LLC, Stamford, CT (US)

(72) Inventors: Chetan Shah, Stamford, CT (US); Junior Villegas, Stamford, CT (US); Priyanka Gundania, Stamford, CT (US); Rafael Chavez, Stamford, CT (US)

(21) Appl. No.: 17/518,277

(22) Filed: Nov. 3, 2021

Related U.S. Application Data
(60) Provisional application No. 63/109,089, filed on Nov. 3, 2020.

(51) Int. Cl. G06Q 10/08

(52) U.S. Cl. CPC G06Q 10/083

(57) ABSTRACT

Disclosed is a communication system for managing distribution of products and a method thereof. The communication system and a method comprise receiving one or more inputs from a plurality of user devices; validating the inputs by using a validation technique; storing the validated inputs, pre-defined filters, products related information, pre-determined conditions and pre-determined rules; creating a plurality of logics based on the stored data; integrating the created logics and generating at least one action; generating at least one real-time response based on the generated action; and triggering the real-time response on the user devices to provide the real-time product delivery information pertaining to each of the product.

### CROSS-REFERENCE TO RELATED APPLICATION

This application claims the benefit of U.S. Provisional Application No. 63/109,089 filed Nov. 3, 2020, which is incorporated herein by reference in its entirety.

### TECHNICAL FIELD

The present disclosure described herein, in general, relates to communication systems and in particular for managing delivery of products.

### BACKGROUND

Typically, communication management systems enable organizations to manage communication across a world. These communication systems send out communication in the form of emails and/or texts to an individual or a group of contacts, automatically or on a command. However, these systems suffer from various disadvantages.

A distribution industry magnifies exponentially a level of complexity for information management versus stand-alone organizations (such as, brands or retailers). Distributors sit in between, potentially, thousands of manufacturers on one end and service, potentially, tens of thousands of retailers on a customer end. This provides millions of supplier-customer level considerations which drive complexity, poor quality, long cycle times and impact profitability for distributors.

To use the core functionalities for communication, a user has to use different stand-alone existing systems in a siloed manner and then work to connect the systems to achieve the outcomes which are delivered in a stand-alone solution. For example, the user has to use a communication portal for sending text/emails, a rule engine for query builder and parser, a business intelligence system for dashboards and scoreboards on activities, and the like.

Therefore, there is a need of a communication system and method that that are unique to the distribution industry and overcome the above limitations.

### SUMMARY

Before the present communication system(s) for managing distribution of products and method(s) thereof are described, it is to be understood that this application is not limited to the particular communication system(s) and methodologies described, as there can be multiple possible embodiments which are not expressly illustrated in the present disclosure. It is also to be understood that the terminology used in the description is for the purpose of describing the particular implementations or versions or embodiments only and is not intended to limit the scope of the present application. This summary is provided to introduce aspects related to a communication system for managing distribution of products and a method thereof. This summary is not intended to identify essential features of the claimed subject matter nor is it intended for use in determining or limiting the scope of the disclosure.

In one implementation, a communication system, a method and a non-transitory computer readable medium embodying a program executable in a computing device for managing distribution of products are disclosed.

In one aspect, a method for managing distribution of products is disclosed. The method includes a step of receiving, by a receiving module, one or more inputs from a plurality of user devices. The method includes a step of validating, by a validation module, the inputs by using a validation technique. The method includes a step of storing, in a database, the validated inputs, pre-defined filters, products related information, and pre-determined rules. The method includes a step of creating, by a logic creation module, a plurality of logics based on the stored data. The method includes a step of integrating, by an integration module, the created logics and generating at least one action. The method includes a step of generating, by a response module, at least one real-time response based on the generated action. The method further includes a step of triggering, by the response module, the real-time response on the user devices to provide the real time product delivery information pertaining to each of the product.

In one aspect, a communication system for managing distribution of products is disclosed. The communication system comprising one or more user devices and a processing engine. Each user device is associated with a user. The processing engine further includes a receiving module, a validation module, a database, a logic creation module, an integration module, and a response module. The receiving module is configured to receive one or more inputs from the user devices. The validation module is configured to validate the inputs by using a validation technique. The database is configured to store the validated inputs, pre-defined filters, products related information, and pre-determined rules. The logic creation module is configured to create a plurality of logics based on the stored data. The integration module is configured to integrate the created logics and generate at least one action. The response module is configured to generate at least one real-time response based on the generated action and trigger the real-time response on the user devices to provide the real-time product delivery information pertaining to each of the product.

In yet another embodiment of the present invention, a computer program product is provided. The computer program product comprises a non-transitory computer-readable storage medium which stores a set of instructions. The set of instructions, when executed by a computing device, cause the computing device to perform the operations of receiving one or more inputs from a plurality of user devices; validating the inputs by using a validation technique; storing the validated inputs, pre-defined filters, products related information, and pre-determined rules; creating a plurality of logics based on the stored data; integrating the created logics and generating at least one action; generating at least one real-time response based on the generated action; and triggering the real-time response on the user devices to provide the real time product delivery information pertaining to each of the product.

### BRIEF DESCRIPTION OF THE DRAWINGS

The foregoing detailed description of embodiments is better understood when read in conjunction with the appended drawings. For the purpose of illustrating the disclosure, there is shown in the present document example constructions of the disclosure; however, the disclosure is not limited to the specific methods and apparatus disclosed in the document and the drawings.

The present disclosure is described in detail with reference to the accompanying figures. In the figures, the left-most digit(s) of a reference number identifies the figure in which the reference number first appears. The same numbers are used throughout the drawings to refer various features of the present subject matter.

FIG. 1 illustrates a block diagram depicting a communication system for managing distribution of products, in accordance with an embodiment of the present disclosure.

FIG. 2 illustrates a block diagram depicting various components of a communication system of a FIG. 1, in accordance with an embodiment of the present disclosure.

FIG. 3 illustrates a schematic diagram depicting functionalities of components of a communication system, in accordance with an exemplary embodiment of the present disclosure.

FIG. 4 illustrates a schematic diagram depicting an architecture of a communication system, in accordance with an exemplary embodiment of the present disclosure.

FIG. 5 illustrates a flow diagram depicting validation of user inputs, in accordance with an exemplary embodiment of the present disclosure.

FIG. 6 illustrates a flow diagram depicting creation of a rule with filters, in accordance with an exemplary embodiment of the present disclosure.

FIG. 7 illustrates a flow diagram depicting creation of a rule without filters, in accordance with an exemplary embodiment of the present disclosure.

FIG. 8 illustrates a flow diagram depicting creation of a template, in accordance with an exemplary embodiment of the present disclosure.

FIG. 9 illustrates a flow diagram depicting sending a reminder by creating a new logic for recurring orders, in accordance with an exemplary embodiment of the present disclosure.

FIG. 10 illustrates a flow diagram depicting sending a reminder by selecting recurring orders and creating a new logic, in accordance with an exemplary embodiment of the present disclosure.

FIG. 11 illustrates a flow diagram depicting post notifications sent scenarios, in accordance with an exemplary embodiment of the present disclosure.

FIG. 12 illustrates a flow diagram depicting functionalities of a processing engine, in accordance with an exemplary embodiment of the present disclosure.

FIG. 13 illustrates a flow chart depicting a method for managing distribution of products, in accordance with an embodiment of the present disclosure.

FIG. 14a illustrates a use case scenario depicting a schema figure for a database entity data table, in accordance with an exemplary embodiment of the present disclosure.

FIG. 14b illustrates a use case scenario depicting a process and a query for selecting main primary entity in for-each section, in accordance with an exemplary embodiment of the present disclosure.

FIG. 14c illustrates a use case scenario depicting a rule search criterion includes a section, in accordance with an exemplary embodiment of the present disclosure.

FIG. 14d illustrates a use case scenario depicting Attribute Type Settings, in accordance with an exemplary embodiment of the present disclosure.

FIG. 14e illustrates a use case scenario depicting options that are assigned to an Attribute Type, in accordance with an exemplary embodiment of the present disclosure.

FIG. 14f illustrates a use case scenario depicting assigning an Attribute Type to an attribute, in accordance with an exemplary embodiment of the present disclosure.

FIG. 14g illustrates a use case scenario depicting option settings, in accordance with an exemplary embodiment of the present disclosure.

FIG. 14h illustrates a use case scenario depicting a rule criterion excludes a section, in accordance with an exemplary embodiment of the present disclosure.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any communication systems and methods, similar or equivalent to those described herein can be used in the practice or testing of embodiments of the present disclosure, the exemplary, communication systems and methods are now described. The disclosed embodiments for managing distribution of products are merely examples of the disclosure, which may be embodied in various forms.

Various modifications to the embodiment will be readily apparent to those skilled in the art and the generic principles herein may be applied to other embodiments. For example, although the present disclosure will be described in the context of a communication system and a method, it will readily recognize that the method and communication system can be utilized in any situation where there is a need to manage distribution of products. Thus, the present disclosure is not intended to be limited to the embodiments illustrated but is to be accorded the widest scope consistent with the principles and features described herein.

As described in the previous section, the conventional customer communication systems exist which send out emails and/or texts to an individual or a group of contacts, automatically or on a command. However, these systems suffer from various disadvantages.

In an embodiment, the present disclosure provides a communication system and method which provide a solution that triggers messaging capabilities combining operation rules and location data that automatically sends out messages. The location data can be used both as a “trigger” to decide if a response should go out as well as a driver of a content, for example, “your package is only two stops away.” Exemplary operation rules include, but are not limited to, sending a response message with a suggested replacement item to any user whose order will ship tomorrow and have not yet replaced an item within their order which is currently out of stock; sending a response message to the users only within a specific region who meet the criteria for a certain promotion; and sending a response message to any user if their scheduled route changes advising of the change and notifying them of the new estimated time of arrival for their order.

In an embodiment, the communication system and method combine a core functionality within three normally stand-alone systems, i.e., a communications portal (short message service and email), a rule engine (query builder and data parser) and business intelligence (dashboards and scorecards on activities). Without using the present communication system and method, users need to solve for these three capabilities in a siloed manner and then work to connect systems to achieve the outcomes which are delivered in a stand-alone solution.

In an embodiment, the communication system and method address a workflow that are unique to a distribution industry and in ways not done before. The distribution industry magnifies exponentially a level of complexity for information management versus stand-alone organizations (such as brands or retailers). Distributors sit in between, potentially, thousands of manufacturers on one-end and service, potentially, tens of thousands of retailers on the customer end. This provides millions of supplier-customer level considerations which drive complexity, poor quality, long cycle times and impact profitability for distributors. The communication system and method as disclosed in the present disclosure has a duality of being the “middle man” and serving both sides of an equation.

In one embodiment of the present subject matter, a communication system and method for managing distribution of products are disclosed. In the embodiment, one or more inputs from one or more user devices have been received. Upon receiving the inputs, the system and method validate the inputs by using a validation technique. The system and method further store the validated inputs, pre-defined filters, products related information, and pre-determined rules. In an embodiment, the system and method create a plurality of logics based on the stored data, and then integrate the created logics and generate at least one action. After integration the logics, the system and method generate at least one real-time response based on the generated action and trigger the real time response on the user devices to provide the real-time product delivery information pertaining to each of the product.

While aspects of described communication system and method for managing distribution of products may be implemented in any number of different computing communication systems, environments, and/or configurations, the embodiments are described in the context of the following exemplary communication system for managing distribution of products.

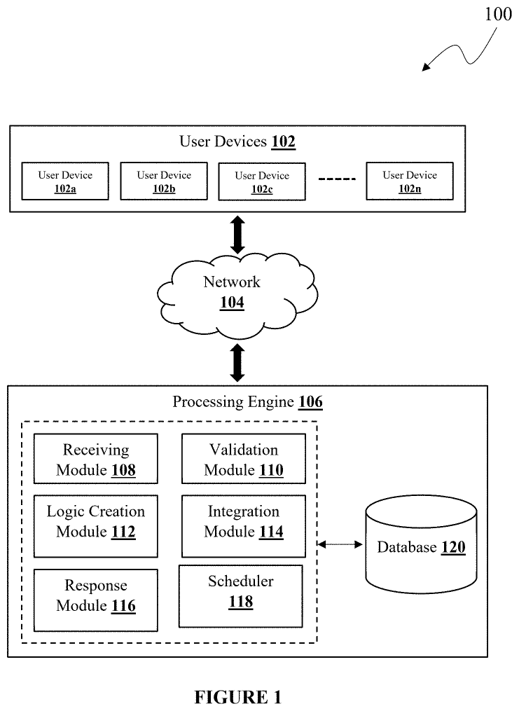

FIG. 1 illustrates a block diagram depicting a communication system (100) for managing distribution of products, in accordance with an embodiment of the present disclosure.

A communication system for managing distribution of products (hereinafter referred to as “communication system”) (100) includes one or more user devices (102), a network (104), and a processing engine (106).

Although the present disclosure is explained considering that the communication system (100) is implemented on a variety of computing systems, such as a laptop computer, a desktop computer, a notebook, a workstation, a mainframe computer, a server, a network server, a cloud-based computing environment and the like. It will be understood that the communication system (100) may be accessed by multiple users through one or more user devices (102a, 102b, 102c, . . . 102n). In one implementation, the communication system (100) may comprise the cloud-based computing environment in which a user, interchangeably may referred to as a consumer, client, retailer, and customer, may operate individual computing systems configured to execute remotely located applications. Examples of the user devices (102) may include, but are not limited to, a portable computer, a personal digital assistant, a handheld device, and a workstation. The user devices (102) are communicatively coupled to the processing engine (106) through the network (104).

In one implementation, the network (104) may be a wireless network, a wired network or a combination thereof. The network (104) can be implemented as one of the different types of networks, such as intranet, local area network (LAN), wide area network (WAN), the internet, and the like. The network (104) may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network (104) may include a variety of network devices, including routers, bridges, servers, computing devices, storage devices, and the like.

In the implementation, the processing engine (106) further includes a receiving module (108), a validation module (110), a logic creation module (112), an integration module (114), a response module (116), and a database (120).

The receiving module (108) is configured to receive one or more inputs from the user devices (102). In an embodiment, the inputs include users' details, product details, location details, requests of the users, and schedule related data. The users' details include, but are not limited to, name, address, contact details, and bank account details.

The validation module (110) is configured to cooperate with the receiving module (108) to receive the received inputs. The validation module (110) is further configured to validate the inputs by using a validation technique. The validation technique includes a variable and field validation technique.

The database (120) is configured to store the validated inputs, pre-defined filters, products related information, and pre-determined rules. In an embodiment, the pre-determined rules include transaction rules related to a product delivery and messaging rules. In another embodiment, the pre-determined filters include categories of products, location of the users, contact and account details of the users. In an embodiment, the database (120) can be an Enterprise resource planning (ERP) database.

The logic creation module (112) is configured to cooperate with the database (118) to receive the stored data. The logic creation module (112) is further configured to create a plurality of logics based on the stored data. In an embodiment, the logic creation module (112) is configured to create the logics by performing data mapping on the validated inputs and by defining data variables. In one embodiment, the logic creation module (112) is further configured to check one or more entities from the stored data and select at least one entity from the checked entities based on the pre-defined filters. The logic creation module (112) then fetches data for the selected entity and a related entity with associated attributes, obtains a condition and a value of the fetched data, and matches the obtained condition with the pre-determined condition. The logic creation module (112) further provides a filtered data set based on the matched condition, and generates the logics based on the filtered data set.

The integration module (114) is configured to cooperate with the logic creation module (112) to receive the created logics. The integration module (114) is further configured to integrate the created logics and generate at least one action.

The response module (116) is configured to cooperate with the integration module (114) to receive the generated action. The response module (116) is further configured to generate at least one real-time response based on the generated action and trigger the real-time response on the user devices (102) to provide the real-time product delivery information pertaining to each of the product.

In an embodiment, the processing engine (106) includes a scheduler (118), which is configured to schedule triggering of the generated response on the user devices (102).

In one embodiment, the communication system (100) may include at least one processor (not shown in a figure), an input/output (I/O) interface (not shown in a figure), and a memory (not shown in a figure). The at least one processor may be implemented as one or more microprocessors, microcomputers, microcontrollers, digital signal processors, central processing units, state machines, logic circuitries, and/or any devices that manipulate signals based on operational instructions. Among other capabilities, the at least one processor is configured to fetch and execute computer-readable instructions stored in the memory.

The I/O interface may include a variety of software and hardware interfaces, for example, a web interface, a graphical user interface, and the like. The I/O interface may allow the communication system (100) to interact with the user directly or through the user devices (102). Further, the I/O interface may enable the communication system (100) to communicate with other computing devices, such as web servers and external data servers (not shown in a figure). The I/O interface can facilitate multiple communications within a wide variety of networks and protocol types, including wired networks, for example, LAN, cable, etc., and wireless networks, such as WLAN, cellular, or satellite. The I/O interface may include one or more ports for connecting a number of devices to one another or to another server.

The memory may include any computer-readable medium or computer program product known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory may include or be communicatively coupled to the different modules and data.

In another embodiment, the modules also include routines, programs, objects, components, data structures, etc., which perform particular tasks or implement particular abstract data types. In one implementation, the modules may include the receiving module (108), the validation module (110), the logic creation module (112), the integration module (114), the response module (116), the scheduler (118), and other modules. The other modules may include programs or coded instructions that supplement applications and functions of the communication system (100). The modules described herein may be implemented as software modules that may be executed in the cloud-based computing environment of the communication system (100).

The data, amongst other things, serves as a repository for storing data processed, received, and generated by one or more of the modules. The data 210 may also include a system data and other data. The other data may include data generated as a result of the execution of other modules, and the system data may include data generated as a result of the execution of the receiving module (108), the validation module (110), the logic creation module (112), the integration module (114), the response module (116), the scheduler (118).

In one implementation, at first, a user may use the user device (102) to access the communication system (100) via the I/O interface. The user may register themselves using the I/O interface in order to use the communication system (100). In one aspect, the user may access the I/O interface of the communication system (100) for customizing the communication system (100) and generating real-time responses.

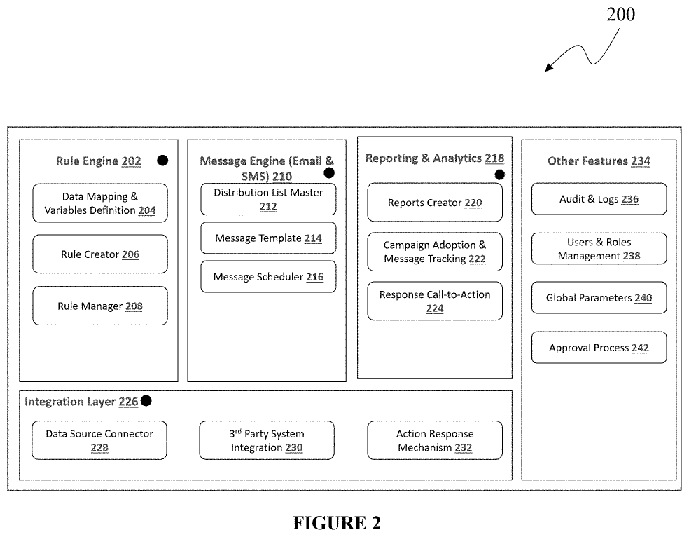

FIG. 2 illustrates a block diagram (200) depicting various components of a communication system of a FIG. 1, in accordance with an embodiment of the present disclosure.

In an embodiment, a logic creation module (112) is configured to create a plurality of logics based on the stored data. The stored data includes the validated inputs, pre-defined filters, products related information, and pre-determined rules. In another embodiment, the communication system (100) is configured to determine rules for creating the logics. The communication system (100) includes a rule engine (202) which is configured to determine and manage rules. In one embodiment, the rule engine (202) includes the logic creation module (112). The rule engine (202) is configured to provide data mapping and variables definition (204). The rule engine (202) includes a rule creator (206) and a rule manager (208). The rule creator (206) is configured to create new rules based on real-time situation. The rule manager (208) is configured to manage the pre-determined rules and the created new rules for further processing. In an embodiment, the rule creator (206)/rule manager (208) holds all conditions, notification template, and time information.

The communication system (100) further includes a message engine (210) which sends out email and/or text responses to the user devices (102). In one embodiment, the message engine (210) includes a response module (116) and a scheduler (118). The message engine (210) provides a distribution list master (212), a message template (214), and a message scheduler (216). The distribution list master (212) can be accessed by a user, which helps to eliminate the need to store the same large distribution list in more than one mailbox. The distribution list master (212) filtered out the result sets with applied conditions at a rule level. The message engine (210) is configured to automatically generate the message template (214) to communicate with the users associated with their respective user devices (102). The message scheduler (216) is a scheduler (118) as shown in FIG. 1. The scheduler (118) is configured to schedule triggering of the generated real-time response on the user devices (102).

In an embodiment, the communication system (100) provides a functionality of reporting and analytics (218). In one embodiment, the response module (116) is configured to generate at least one real-time response based on the generated action and trigger the real-time response on the user devices (102) to provide the real-time product delivery information pertaining to each of the product. The communication module (100) further analyses and reports the generated response to the user devices (102) by creating real-time reports (220), adapting campaign and tracking of the generated response (i.e., a message) (222), and performing a response call-to-action (224).

In one embodiment, an integration layer (226) includes the integration module (114) as shown in FIG. 1, which is configured to integrate the created logics and generate at least one action. The integration layer (226) provides a data source connector (228), third party system integration (230), and action response mechanism (232). In an embodiment, the data source connector (228) is configured to move data from one database/storage medium to another. The data source connector (228) includes a file transfer protocol (FTP) and a Simple Storage Service (S3) for automatically loading data once a target data file is found. The third-party system integration includes Mailgun® and AWS Pinpoint Services®. Further, the action response mechanism includes email and SMS to trigger out with their attached templates.

In another embodiment, the communication provides other features (234), which include audit and logs (236), users and roles management (238), global parameters (240), and an approval process (242). The audit and logs (236) record events of the communication system (100). The users and management (238) define roles for the users and control access to the communication system (100). The global parameters (240) include device parameters, delivery of products, and other transaction related parameters. The approval process (242) is a real-time approval process between an administrator and the users.

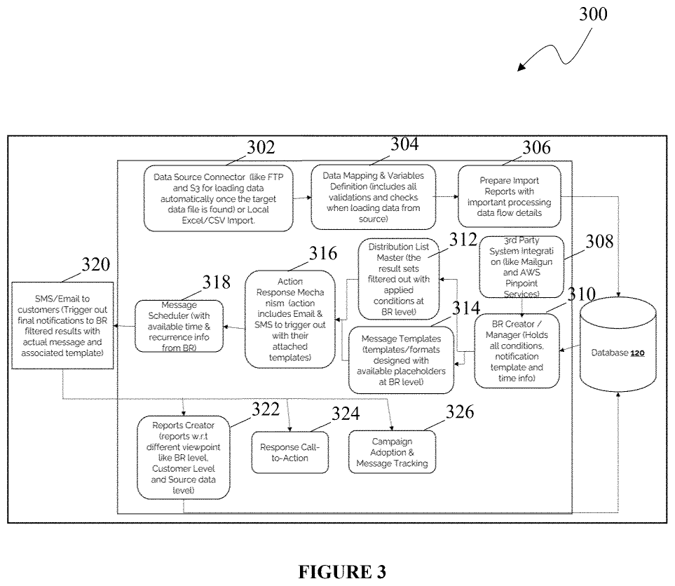

FIG. 3 illustrates a schematic diagram (300) depicting functionalities of components of a communication system, in accordance with an exemplary embodiment of the present disclosure.

In FIG. 3, at a block (302), a data source connector, such as the FTP and S3, automatically loads data once the target data file is found, or import a local excel/comma-separated values files. The logic creation module (112) of FIG. 1 defines data mapping and variables. At a block (304), the data mapping and variables includes all validations and checks when loading data from a source. At a block (306), prepare import reports with important processing data flow details. In an embodiment, a response module (116) is configured to prepare import reports. The prepared reports are then stored in the database (120). At a block (308), third party system integration is present. The third-party system integration includes Mailgun® and AWS Pinpoint Services®. At a block (310), the rule creator (206)/rule manager (208) of the rule engine (202) holds all conditions, notification template, and time information. At a block (312), a distribution list master filtered out the result sets with applied conditions at a rule level. In one embodiment, the rule level is a business rule level. At a block (314), message templates designed with available placeholders at the business rule level. At a block (316), action response mechanism includes email and SMS to trigger out with their attached templates. At a block (318), the message scheduler schedules the trigger with available time and recurrence information from the business rule. At a block (320), the response module (116) triggers out the response to the business rule filtered results with an actual message and associated template. At a block (322), the report creator reports with respect to different viewpoint like a business rule level, a user (for example, a customer) level and a source data level). At a block (324), response call-to-action is performed. At a block (326), campaign adoption and message tracking are performed.

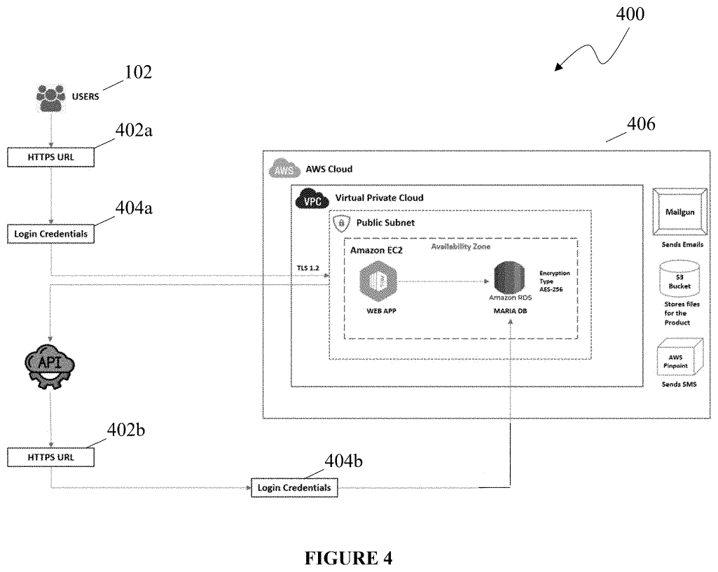

FIG. 4 illustrates a schematic diagram depicting an architecture (400) of a communication system (100), in accordance with an exemplary embodiment of the present disclosure.

In an exemplary embodiment, the communication system (100) is hosted on an AWS® Cloud (406) and is encrypted as AES-256 in a virtual private container. The communication system (100) is also using other services from AWS® like Pinpoint for sending and tracking SMS and AWS S3® Bucket as a file storage and managing service. The communication system (100) uses Mailgun® services for handling email and tracking features (like delivery, bounce backs etc.). The communication system (100) is accessible from a web application (402) under AWS EC2® and via API REST® services. The database (120) is under Amazon RDS® mask and a database type is of Maria DB®.

In an embodiment, one or more users with their associated user devices (102) access the communication system (100) by providing login credentials (404a). In an embodiment, before using the communication system (100), the user has to create a personal account by providing authentication details for a security purpose. The user will open a hyperlink (402a) on a web browser and enters the login credential (404a) to access the communication system (100). In an embodiment, the communication system (100) may be implemented on a cloud based computing environment (406) which includes a virtual private cloud. The virtual private cloud has a public subnet having third-party integration, which includes an encryption technique, for example Encryption Type AES-256 that encrypts the user request received from the web browser. The third-party system integration includes Mailgun® and AWS Pinpoint Services® which send email and SMS respectively, to the user devices (102). A Simple Storage Service (S3) bucket automatically loads product related data once a target data file is found. An Application Programming Interface (API) accesses data cloud data and provide a hyperlink (402b) where the users will enter their login credentials (404b) to access the cloud (406) by sending API request to the cloud.

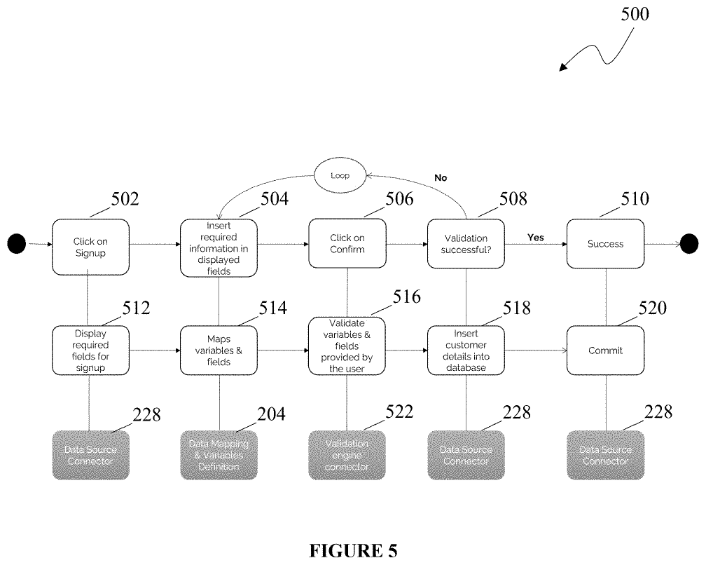

FIG. 5 illustrates a flow diagram (500) depicting validation of user inputs, in accordance with an exemplary embodiment of the present disclosure.

In FIG. 5, the data source connector (228) loads fields and display required field for signup, as shown at a block (512). At a block (502), a user provides one or more inputs for the required fields and then click on a signup. The data mapping and variable definitions (204) provide mapping of variables and field (as shown at a block (514)). After signup, the user inserts required information as inputs in displayed fields, as shown at a block (504). A validation engine connector (522) is configured to validate variables and fields provided by the user, as shown at a block (516). At a block (506), the user clicks on “confirm” after inserting the required information. The validation engine connector (522) then validates the variables and fields provided by the user. If the variables and fields are validated (as shown at a block (508)), the communication system (100) shows “success”, as shown at a block (510), else it loops the process and goes back to the block (504) to repeat the process. In an embodiment, the data source connector (228) is configured to insert user's details in the database (120) after successful validation, as shown at a block (518). The data source connector (228) then commits the data and validated the user inputs and continue further processing, as shown at a block (520).

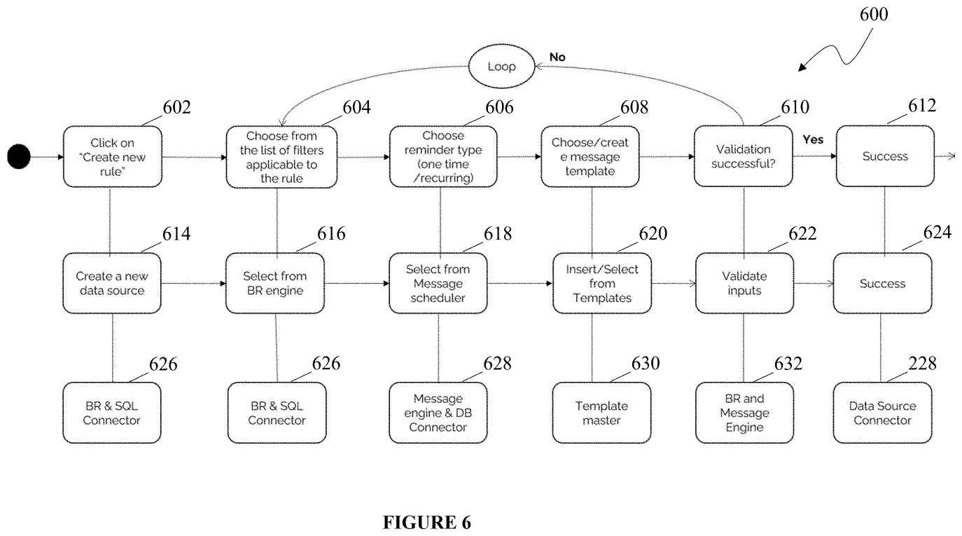

FIG. 6 illustrates a flow diagram (600) depicting creation of a rule with filters, in accordance with an exemplary embodiment of the present disclosure.

In an exemplary embodiment, the communication system (100) is configured to create at least one type of a rule with filters. The created rule may include a business rule. At a block (602), a user clicks on a function of creating new rule. In an embodiment, a business rule (BR) and structured query language (SQL) connector (626) is configured to create a new data source, as shown at a block (614). After clicking on the creating new rule, the user chooses from a list of filters applicable to the rule, as shown at a block (604). In an embodiment, the BR & SQL connector (626) is configured to select a list of filters from the rule engine (202), as shown at a block (616). At a block (606), the user chooses a reminder type, i.e., one-time reminder or recurring reminder. In an embodiment, a message engine and database connector (626) are configured to select the reminder type from the scheduler (118), as shown at a block (618). At a block (608), the user then chooses a message template or create a customized message template. In an embodiment, a template master (630) is configured to insert or select customized templates from a plurality of templates, as shown at a block (620). At a block (610), the communication system (100) validates the templates. In an embodiment, a BR and message engine (632) is configured to validate one ore more inputs provided by the user for template creation, as shown at a step (622). If the templates are validated, the communication system (100) shows “success”, as shown at a block (612), else it loops the process and goes back to the block (604). In an embodiment, the data source connector (228) provides success after validated inputs for template creation, as shown at a block (624).

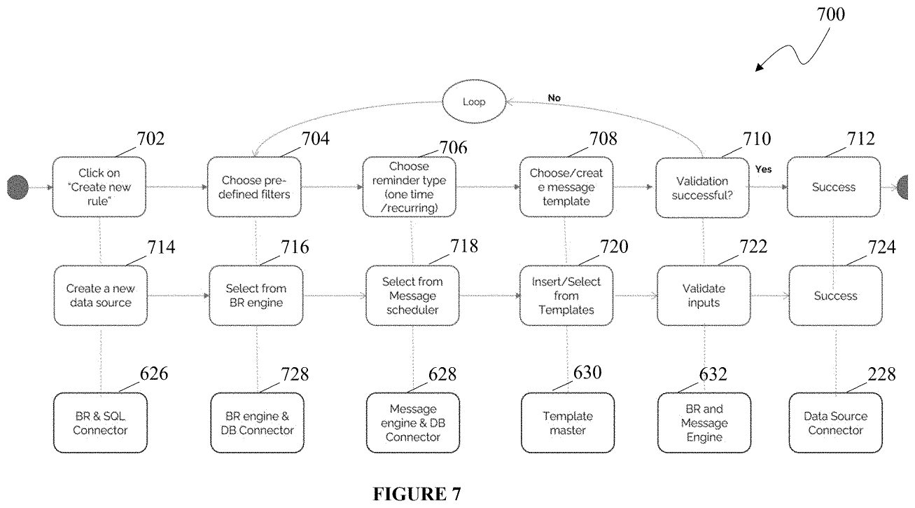

FIG. 7 illustrates a flow diagram (700) depicting creation of a rule without filters, in accordance with an exemplary embodiment of the present disclosure.

In an exemplary embodiment, the communication system (100) is configured to create at least one type of a rule without filters. The created rule may include a business rule. At a block (702), a user clicks on a function of creating new rule. In an embodiment, a business rule (BR) and structured query language (SQL) connector (626) is configured to create a new data source, as shown at a block (714). After clicking on the creating new rule, the user chooses pre-defined filters, as shown at a block (704). In an embodiment, the rule engine & database connector (728) is configured to select the pre-defined filters from the rule engine (202), as shown at a block (716). At a block (706), the user chooses a reminder type, i.e., one-time reminder or recurring reminder. In an embodiment, a message engine and database connector (626) are configured to select the reminder type from the scheduler (118), as shown at a block (718). At a block (708), the user then chooses a message template or create a customized message template. In an embodiment, a template master (630) is configured to insert or select customized templates from a plurality of templates, as shown at a block (720). At a block (710), the communication system (100) validates the templates. In an embodiment, a BR and message engine (632) is configured to validate one or more inputs provided by the user for template creation, as shown at a step (722). If the templates are validated, the communication system (100) shows “success”, as shown at a block (712), else it goes back to the block (704) to loop the process. In an embodiment, the data source connector (228) provides success after validated inputs for template creation, as shown at a block (724).

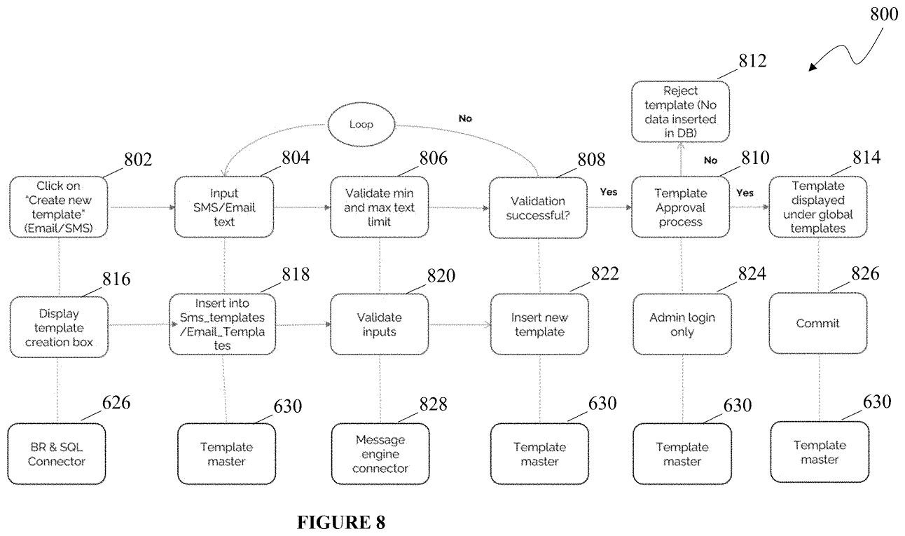

FIG. 8 illustrates a flow diagram (800) depicting creation of a template, in accordance with an exemplary embodiment of the present disclosure.

In an exemplary embodiment, the communication system (100) facilitates the user to create the response/message templates or customized the templates. The BR and SQL connector (626) is configured to create and display a template creation box on the user device (102) associated with a user, as shown at a block (816). The user then clicks on a feature of creating new template for email and/or text messages, as shown at a block (802). At a block (804), the user inputs email and/or text messages body. In an embodiment, the template master (630) is configured to insert templates into the template creation box in a format of Sms_templates or Email_templates. At a block (806), the communication system (100) checks the text size and validate the text by using minimum and maximum pre-defined text size limit. In an embodiment, a message engine connector (828) is configured to validate the text/inputs, as shown at a block (820). At a block (808), the communication system (100) checks whether validation is successful or not. If the validation is successful, a template approval process begins from a block (810), else it loops the process and goes back to the block (804). In an embodiment, the template master (630) inserts a new template after validating the inputs, as shown at a block (822). At a block (810), the communication system (100) approves the template after validation. If the communication system (100) approves the template, the template will be displayed user global templates or considered as a pre-defined template and stored in the database (120), as shown at a block (814). If the template is rejected, no template data will be inserted in the database (120), as shown at a block (812). In an embodiment, the template master (630) provides authorization to an administrator for template approval, as shown at a block (824) and commits the displayed templates in the database (120), as shown at a block (826).

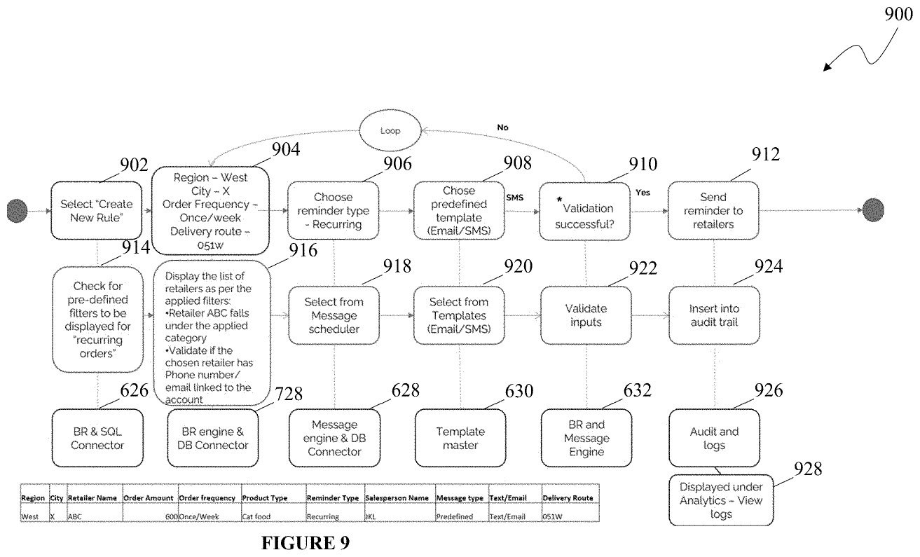

FIG. 9 illustrates a flow diagram (900) depicting sending a reminder by creating a new logic for recurring orders, in accordance with an exemplary embodiment of the present disclosure.

In an exemplary embodiment, a user provides login credentials and enter into the communication system (100). The user first selects a feature of creating a new rule, as shown at a block (902). In an embodiment, the BR and SQL connector (626) are configured to check for pre-defined filters to be displayed for ‘recurring orders’, as shown at a block (914), where the user selects the feature of the creation of a new rule. The rule engine and the database connector (728) display a list of retailers/users as per the applied filters, for example, a retailer ABC falls under the applied category, and validate if the chosen retailer has phone number/email linked to the account, as shown at a block (916). For example, at a block (904), the retailer enters the details, for example, Region—West, City—X, Order Frequency—Once/week, and Delivery route—051w. At a block (906), the user chooses a reminder type, for example, recurring reminder. In an embodiment, the message engine and the database connector (628) are configured to choose reminder type which is selected by the scheduler (118), as shown at a step (918). At a block (908), the user chooses a predefined template for email and/or text messages. In an embodiment, the template master (630) is configured to select the pre-defined templates from the global templates, as shown at a step (920). At a step (910), the communication system (100) validates the chosen template. If the validation is successful, the communication system (100) sends a reminder to retailers, as shown at a step (912), else it loops the process and goes back to the block (904). In an embodiment, the rule engine and message engine (632) validate the inputs, i.e., selecting the templates, as shown at a block (922). The validated inputs are then inserted in an audit trial, as shown at a block (924). In an embodiment, the audit and logs (926) perform audit trial on the validated inputs and displayed user analytics as a view log, as shown at a block (928).

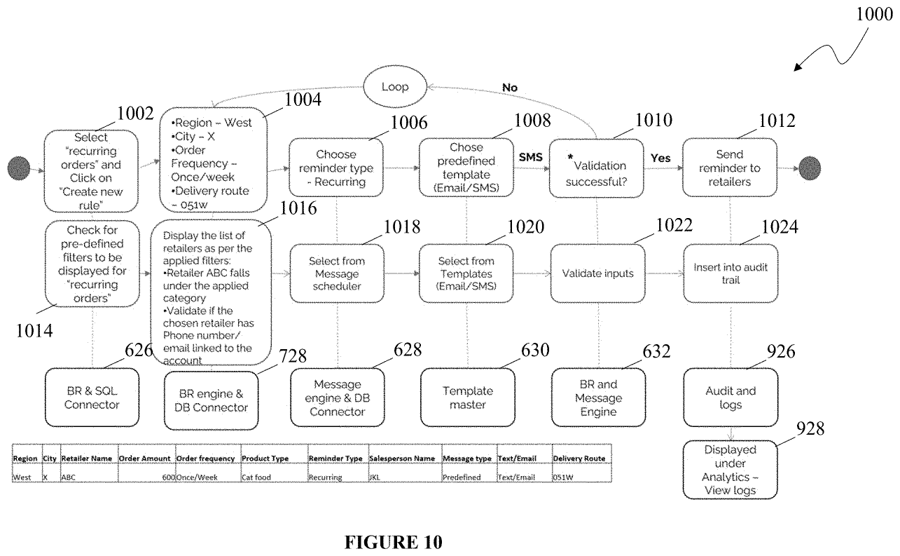

FIG. 10 illustrates a flow diagram (1000) depicting sending a reminder by selecting recurring orders and creating a new logic, in accordance with an exemplary embodiment of the present disclosure.

In an exemplary embodiment, a user provides login credentials and enter into the communication system (100). The user first selects features of selecting recurring orders and then clicking on creating a new rule, as shown at a block (1002). In an embodiment, the BR and SQL connector (626) are configured to check for pre-defined filters to be displayed for ‘recurring orders’, as shown at a block (1014), where the user selects the feature of the creation of a new rule. The rule engine and the database connector (728) display a list of retailers/users as per the applied filters, for example, a retailer ABC falls under the applied category, and validate if the chosen retailer has phone number/email linked to the account, as shown at a block (1016). For example, at a block (1004), the retailer enters the details, for example, Region—West, City—X, Order Frequency—Once/week, and Delivery route—051 w. At a block (1006), the user chooses a reminder type, for example, recurring reminder. In an embodiment, the message engine and the database connector (628) are configured to choose reminder type which is selected by the scheduler (118), as shown at a step (1018). At a block (1008), the user chooses a predefined template for email and/or text messages. In an embodiment, the template master (630) is configured to select the pre-defined templates from the global templates, as shown at a step (1020). At a step (1010), the communication system (100) validates the chosen template. If the validation is successful, the communication system (100) sends a reminder to retailers, as shown at a step (1012), else it loops the process and goes back to the block (1004). In an embodiment, the rule engine and message engine (632) validate the inputs, i.e., selecting the templates, as shown at a block (1022). The validated inputs are then inserted in an audit trial, as shown at a block (1024). In an embodiment, the audit and logs (926) perform audit trial on the validated inputs and displayed user analytics as a view log, as shown at a block (928).

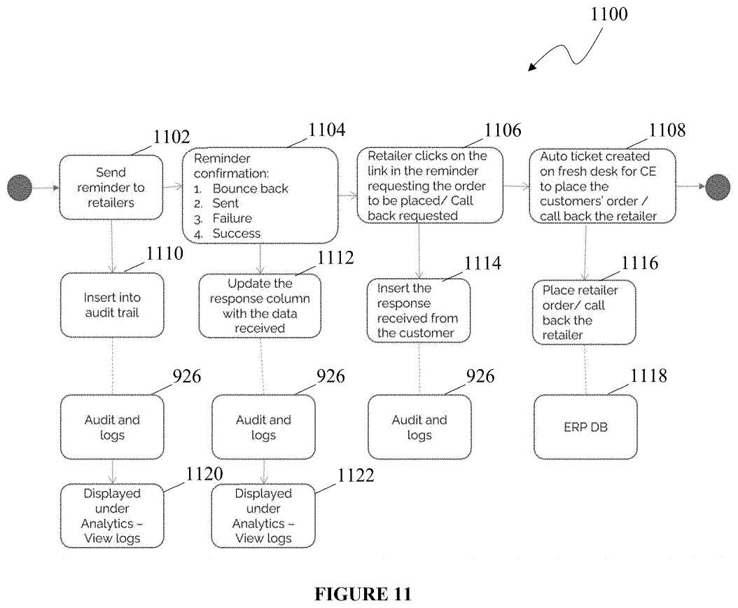

FIG. 11 illustrates a flow diagram (1100) depicting post notifications sent scenarios, in accordance with an exemplary embodiment of the present disclosure.

In an exemplary embodiment, the communication system (100) is configured to send a reminder to the user devices which are associated with the users (i.e., retailers), as shown at a block (1102). In an embodiment, audit and logs (926) inserts the sent reminder into an audit trail, as shown at a block (1110) that displayed under analytics as a view log (shown at a block (1120)). At a block (1104), the communication system (100) confirms the whether the reminder has been sent or not. The communication system (100) confirms the reminder by checking the status as bounce back, sent, failure, or success. In an embodiment, the audit and logs (926) update a response column with the data received, as shown at a block (1112), that displayed under analytics as a view log (shown at a block (1122)). At a block (1106), a retailer clicks on a link in the reminder message requesting an order of a product to be placed or call back requested. In an embodiment, audit and logs (926) insert the response input received from the user, as shown at a block (1114). At a block (1108), an auto ticket is created on a fresh desk for conformity to place the customers order/call back the retailer. In an embodiment, an Enterprise resource planning (ERP) database (1118) places the retailer order/call back the retailer.

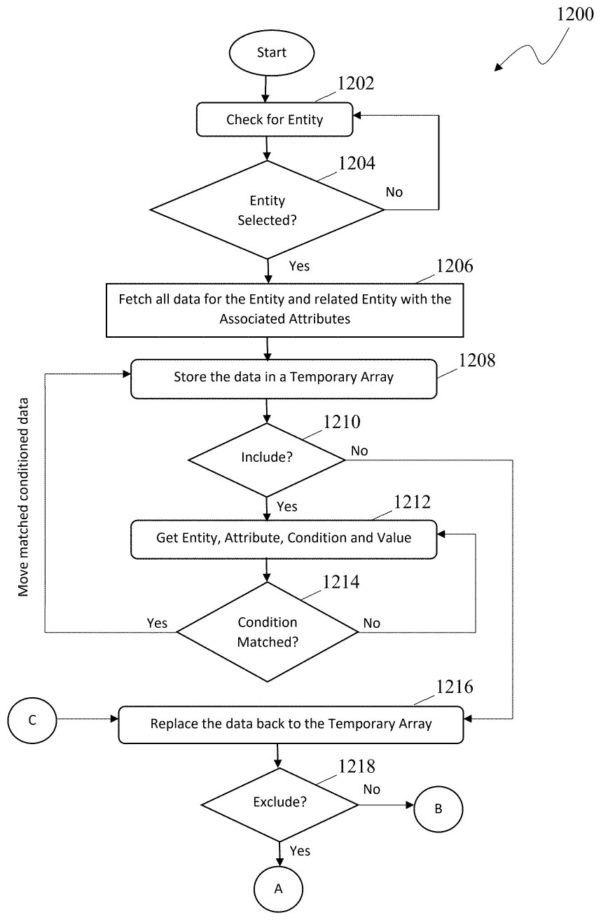

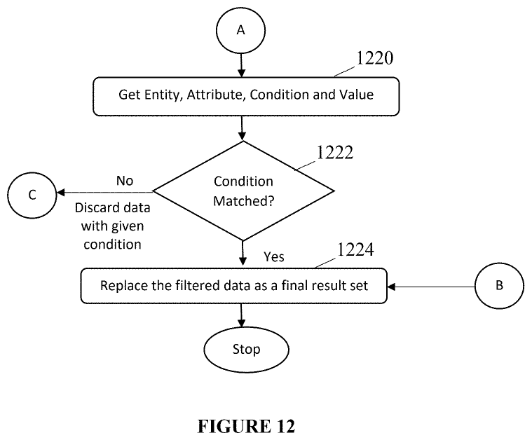

FIG. 12 illustrates a flow diagram (1200) depicting functionalities of a processing engine (106), in accordance with an exemplary embodiment of the present disclosure.

In FIG. 12, a process starts from a step (1202), check for entity. In an embodiment, the entity can be a user, a product, or any distribution agencies. At a step (1204), the processing engine (106) checks whether any entity is selected. If the entity is not selected, the process goes back at the step (1202) and repeat the process. If the entity is selected, the processing engine (106) fetches all data for the entity and a related entity with their associated attributes, as shown at a step (1206). At a step (1208), the processing engine (106) stores the data in a temporary array. The processing engine (106) further checks whether the data is included in the array or not, as shown at a step (1210). If the data is included, the processing engine (106) gets the entity, attribute, condition, and value, as shown at a step (1212). The processing engine (106) further checks whether the condition matched or not, as shown at a step (1214). If the condition is matched, the processing engine (106) moves the matched conditioned data and stores the data in the temporary array (as shown at the step (1208). If the data is not included at the step (1210), the processing engine (106) replaces the data back to the temporary array, as shown at a step (1216). The processing engine (106) further checks whether the replaced data is excluded from the temporary array, as shown at a step (1218). If the data is excluded, the processing engine (106) gets the entity, attribute, condition, and value, as shown at a step (1220). The processing engine (106) further checks whether the condition matched or not, as shown at a step (1222). If the condition is matched, the processing engine (106) replaces the filtered data as a final result set, else replaces the data back to the temporary array (as shown at the step (1216) by discarding the data with a given condition. If the data is not excluded at the step (1218), the processing engine (106) replaces the filtered data as a final result set, as shown at the step (1224). The process stops at the step (1224).

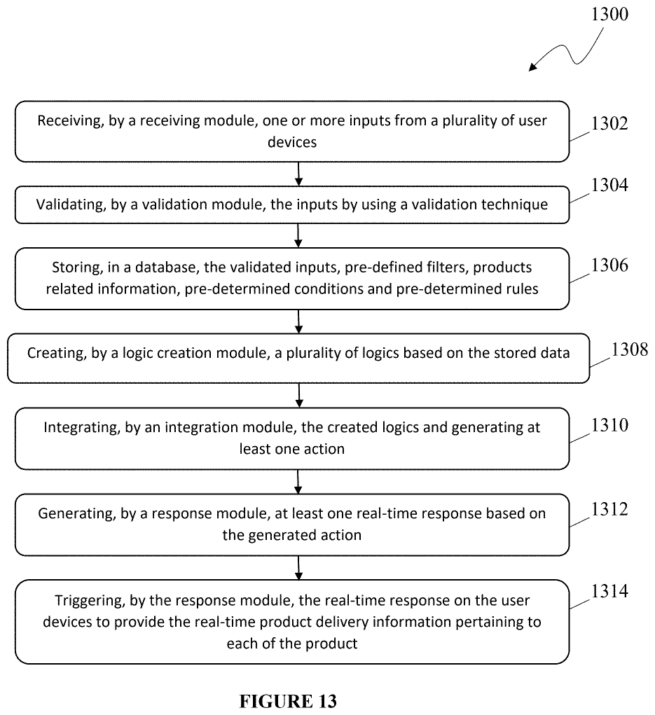

FIG. 13 illustrates a flow chart depicting a method (1300) for managing distribution of products, in accordance with an embodiment of the present disclosure.

The flow chart illustrates a method (1300) for managing distribution of products, in accordance with an embodiment of the present disclosure. The method (1300) may be described in the general context of computer executable instructions. Generally, computer executable instructions can include routines, programs, objects, components, data structures, procedures, modules, functions, etc., that perform particular functions or implement particular abstract data types. The method (1300) may be practiced in a distributed computing environment where functions are performed by remote processing devices that are linked through a communications network. In a distributed computing environment, computer executable instructions may be located in both local and remote computer storage media, including memory storage devices.

The order in which the method (1300) is described is not intended to be construed as a limitation, and any number of the described method blocks can be combined in any order to implement the method (1300) or alternate methods. Additionally, individual blocks may be deleted from the method (1300) without departing from the spirit and scope of the disclosure described herein. Furthermore, the method can be implemented in any suitable hardware, software, firmware, or combination thereof. However, for ease of explanation, in the embodiments described below, the method (1300) may be considered to be implemented in the above described in the communication system (100).

At a step (1302), receiving, by a receiving module, one or more inputs from a plurality of user devices. In one implementation, a receiving module (108) is configured to receive one or more inputs from a plurality of user devices (102). At a step (1304), validating, by a validation module (110), the inputs by using a validation technique. In one implementation, a validation module (110) is configured to validate the inputs by using a validation technique. In an embodiment, the validation technique includes a variable and field validation technique. At a step (1306), storing, in a database, the validated inputs, pre-defined filters, products related information, pre-determined conditions and pre-determined rules. In one implementation, a database (120) is configured to store the validated inputs, pre-defined filters, products related information, pre-determined conditions and pre-determined rules. At a step (1308), creating, by a logic creation module, a plurality of logics based on the stored data. In one implementation, a logic creation module (112) is configured to create a plurality of logics based on the stored data. At a step (1310), integrating, by an integration module, the created logics and generating at least one action. In one implementation, an integration module (114) is configured to integrate the created logics and generate at least one action. At a step (1312)), generating, by a response module, at least one real time response based on the generated action. In one implementation, a response module (116) is configured to generate at least one real-time response based on the generated action. At a step (1314), triggering, by the response module (116), the real-time response on the user devices (102) to provide the real-time product delivery information pertaining to each of the product. In one implementation, the response module (116) is configured to trigger the real-time response on the user devices (102) to provide the real-time product delivery information pertaining to each of the product.

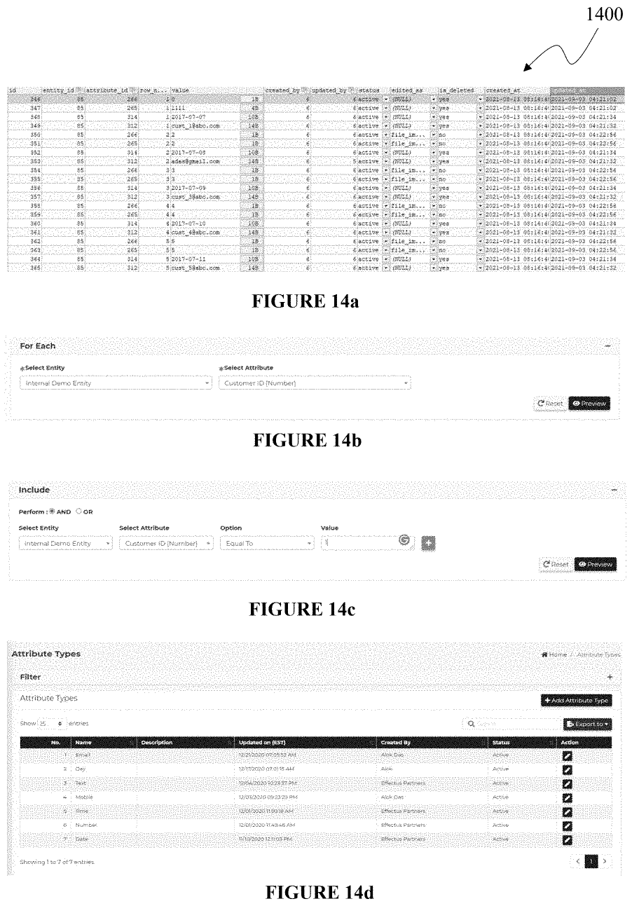

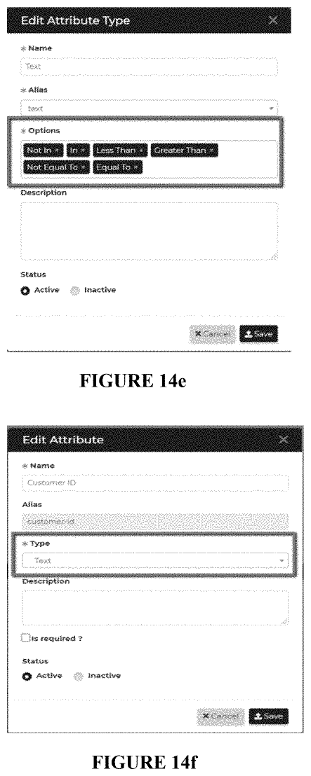

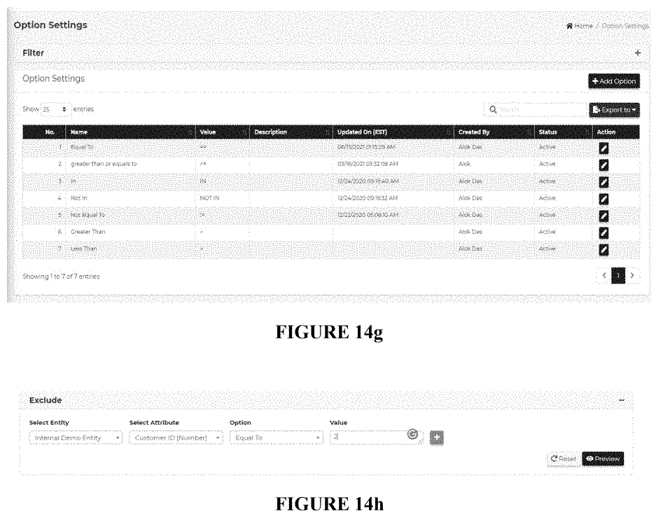

FIG. 14a-14h illustrate use case scenarios depicting a data table and logic creation criterions, in accordance with an exemplary embodiment of the present disclosure.

FIG. 14a illustrates a schema figure for a database entity data table. In an exemplary embodiment, FIG. 14a illustrates a common table for storing every Entity's data, and it clearly shows a “value” column that contains the actual data against each entity and attribute information. Hence, all the business rule search query with conditions ultimately executes on this table providing related entity and attribute information.

FIG. 14b illustrates a process and a query for selecting main primary entity in for-each section. This is Mandatory because all the filtration in Include and Exclude will be done to this Entity. Also, on clicking “preview” on this section will show all the data the entity contains.

FIG. 14c illustrates a rule search criterion includes a section. In an exemplary embodiment, the processing engine (106):
a) checks for “And” or “OR” criteria in an include section—with “AND” criteria each row selection will work as a collective check such that all condition should satisfy for data whereas in “OR” condition each row selection must satisfy individually.
b) Get all Active Entity and its Attribute Information.
Query Sample:
Active Entity List:

```
″select
  ‘id‘ as ‘entity_id‘,
  ‘name‘ as ‘entity_name‘
from ‘entities‘
where (‘status‘ = ? and ‘is_deleted‘ = ?)″
```

Query for the related attribute list and type information:

```
″select
  ‘attributes‘.‘id‘ as ‘attribute_id‘,
  ‘attributes‘.‘name‘ as ‘attribute_name‘,
  ‘attribute_types‘.‘id‘ as ‘attribute_type_id‘,
  ‘attribute_types‘.‘name‘ as ‘attribute_type_name‘
from ‘entities_attributes‘ left join
  (
    ‘attributes‘ left join ‘attribute_types‘
    on ‘attributes‘.‘attribute_type_id‘ = ‘attribute_types‘.‘id‘
  )
on ‘entities_attributes‘.‘attribute_id‘ = ‘attributes‘.‘id‘
where (‘entity_id‘ = ?)″
```

c) Draw the entity and attribute data in a respective drop-down list as shown in FIG. 14c.
d) Select condition and a search value in option and value field respectively: The condition list filters out according to the “Type” of Attribute like a text, number, email etc. and the same is managed from attribute type settings, attribute settings and options settings. Attribute Type Settings is shown in a FIG. 14d.

FIG. 14e illustrates how options are assigned to an Attribute Type. FIG. 14f illustrates how an Attribute Type is assigned to an attribute. FIG. 14g illustrates option settings.
e) Repeat the steps (b) to (d) for a combination of Include conditions.

FIG. 14h illustrates a rule criterion excludes a section. In an exemplary embodiment, the processing engine (106):
a) Get all entity and its related attribute information.
b) Draw the entity and attribute data in respective drop-down list as shown in the FIG. 14c.
c) Select a condition and a search value in option and a value field respectively.
d) Repeat the steps (b) to (d) for a combination of Exclude conditions.

In an exemplary embodiment, a final search query that is applied after each filtration is as follows:

```
″″″
# Pluck the main keys for the data
select
        ‘entity_attribute_data‘.‘entity_id‘,
        ‘entity_attribute_data‘.‘attribute_id‘,
        ‘entity_attribute_data‘.‘row_number‘,
        ‘entity_attribute_data‘.‘value‘
from ‘entity_attribute_data‘
# check for Active and Non deleted Data
where (‘status‘ = ? and ‘is_deleted‘ = ?)
# Filter By selected Entity ID
and ‘entity_id‘ in (?)
# Filter Row Number with series of condition and “AND/OR” operators
#For First Condition the Subquery is as below
#Include Section
and entity_attribute_data.row_number IN
        (
        SELECT ‘row_number‘ FROM ‘entity_attribute_data‘
        WHERE ‘entity_id‘ = ?
          AND ‘attribute_id‘ = ? AND ‘value‘ = ?
      )
#For second Query and likewise for all other condition
and entity_attribute_data.row_number IN
        (
          SELECT ‘row_number‘ FROM ‘entity_attribute_data‘
          WHERE ‘entity_id‘ = ?
            AND ‘attribute_id‘ = ?AND ‘value‘ > ?
    )
#Exclude Section
and entity_attribute_data.row_number NOT IN
        (
        SELECT ‘row_number‘ FROM ‘entity_attribute_data‘
        WHERE ‘entity_id‘ = ?
          AND ‘attribute_id‘ = ? AND ‘value‘ = ?
      )
and entity_attribute_data.row_number NOT IN
        (
        SELECT ‘row_number‘ FROM ‘entity_attribute_data‘
        WHERE ‘entity_id‘ = ?
          AND ‘attribute_id‘ = ? AND ‘value‘ = ?
      )
  order by ‘entity_attribute_data‘.‘attribute_id‘ asc
″″″
```

In one embodiment, the query for the Exclude Criteria is almost same as Include, here for Row Number check “NOT IN” is applied instead of “IN” condition. The processing engine (106) draws the final data after filtration from Include and Exclude into the preview section as the main result set.

In another exemplary embodiment, below are some sample queries with execution time executed with entity size of 1000 data

/*[ Time taken for execution: 655 ms]*/
SELECT * FROM ‘engage_db‘.‘entity_attribute_data‘ WHERE ‘entity_id‘ IN (123) AND
‘row_number‘ IN ( SELECT ‘row_number‘ FROM ‘engage_db‘.‘entity_attribute_data‘
WHERE ‘entity_id‘ = ′123′ AND ‘attribute_id‘ = 255 AND ‘value‘ IS NOT NULL ) AND
‘row_number‘ IN ( SELECT ‘row_number‘ FROM ‘engage_db‘.‘entity_attribute_data‘
WHERE ‘entity_id‘ = ′123′ AND ‘attribute_id‘ = 272 AND ‘value‘ = ′Monday′) AND ‘status‘
= ′active′ AND ‘is_deleted‘ = ′no′ LIMIT 0, 10000;
/*[Time taken for execution: 788 ms]*/
SELECT * FROM ‘engage_db‘.‘entity_attribute_data‘ WHERE ‘entity_id‘ IN (123) AND
‘row_number‘ IN ( SELECT ‘row_number‘ FROM ‘engage_db‘.‘entity_attribute_data‘
WHERE ‘entity_id‘ = ′123′ AND ‘attribute_id‘ = 255 AND ‘value‘ IS NOT NULL ) AND
‘row_number‘ IN ( SELECT ‘row_number‘ FROM ‘engage_db‘.‘entity_attribute_data‘
WHERE ‘entity_id‘ = ′123′ AND ‘attribute_id‘ = 272 AND ‘value‘ = ′Monday′) AND ‘status‘
= ′active′ AND ‘is_deleted‘ = ′no′ LIMIT 0, 1000;
/*[ Time taken for execution: 759 ms]*/
SELECT * FROM ‘engage_db‘.‘entity_attribute_data‘ WHERE ‘entity_id‘ IN (123) AND
‘row_number‘ IN ( SELECT ‘row_number‘ FROM ‘engage_db‘.‘entity_attribute_data‘
WHERE ‘entity_id‘ = ′123′ AND ‘attribute_id‘ = 255 AND ‘value‘ IS NOT NULL ) AND
‘row_number‘ IN ( SELECT ‘row_number‘ FROM ‘engage_db‘.‘entity_attribute_data‘
WHERE ‘entity_id‘ = ′123′ AND ‘attribute_id‘ = 272 AND ‘value‘ = ′Monday′ ) AND
‘row_number‘ IN ( SELECT ‘row_number‘ FROM ‘engage_db‘.‘entity_attribute_data‘
WHERE ‘entity_id‘ = ′123′ AND ‘attribute_id‘ = 257 AND ‘value‘ = ′OH′ ) AND ‘status‘ =
′active′ AND ‘is_deleted‘ = ′no′ LIMIT 0, 1000;
/*[ Time taken for execution: 635 ms]*/
SELECT * FROM ‘engage_db‘.‘entity_attribute_data‘ WHERE ‘entity_id‘' IN (123) AND
‘row_number‘ IN ( SELECT ‘row_number‘ FROM ‘engage_db‘.‘entity_attribute_data‘
WHERE ‘entity_id‘ = ′123′ AND ‘attribute_id‘ = 255 AND ‘value‘ IS NOT NULL ) AND
‘row_number‘ IN ( SELECT ‘row_number‘ FROM ‘engage_db‘.‘entity_attribute_data‘
WHERE ‘entity_id‘ = ′123′ AND ‘attribute_id‘ = 272 AND ‘value‘ = ′Monday′ ) AND
‘row_number‘ IN ( SELECT ‘row_number‘ FROM ‘engage_db‘.‘entity_attribute_data‘
WHERE ‘entity_id‘ = ′123′ AND ‘attribute_id‘ = 257 AND ‘value‘ != ′OH′) AND ‘status‘ =
′active′ AND ‘is_deleted‘ = ′no′LIMIT 0, 1000;

Here, the execution time may vary depending on the size of data and the number of conditions.

Although implementations for methods and communication systems have been described in language specific to structural features and/or methods, it is to be understood that the appended claims are not necessarily limited to the specific features or methods described. Rather, the specific features and methods are disclosed as examples of implementations of managing distribution of products.

We claim:

1. A method for managing distribution of products, said method comprising:
receiving, by a receiving module (108), one or more inputs from a plurality of user devices (102);
validating, by a validation module (110), said inputs by using a validation technique;
storing, in a database (120), said validated inputs, pre-defined filters, products related information, pre-determined conditions and pre-determined rules;
creating, by a logic creation module (112), a plurality of logics based on said stored data;
integrating, by an integration module (114), said created logics and generating at least one action;
generating, by a response module (116), at least one real-time response based on said generated action; and
triggering, by said response module (116), said real-time response on said user devices to provide the real-time product delivery information pertaining to each of the product.

2. The method as claimed in claim 1, comprising a step of creating, by said logic creation module (112), said logics by performing data mapping on said validated inputs and by defining data variables.

3. The method as claimed in claim 1, comprising a step of scheduling, by a scheduler (118), triggering of said generated response on said user devices (102).

4. The method as claimed in claim 1, wherein said step of creating the logic comprising:
checking one or more entities from said stored data;
selecting at least one entity from the checked entities based on said pre-defined filters;
fetching data for said selected entity and a related entity with associated attributes;
obtaining a condition and a value of said fetched data;
matching said obtained condition with said pre-determined condition;
providing a filtered data set based on said matched condition; and
generating said logics based on said filtered data set.

5. The method as claimed in claim 1, wherein said inputs include users details, product details, location details, requests of said users, and schedule related data.

6. The method as claimed in claim 1, wherein said validation technique includes a variable and field validation technique, the length of a response and a text type.

7. The method as claimed in claim 1, wherein said pre-determined rules include transaction rules related to a product delivery and messaging rules.

8. The method as claimed in claim 1, wherein said pre-determined filters include categories of products, location of said users, contact and account details of said users.

9. A communication system (100) for managing distribution of products, said system (100) comprising:
one or more user devices (102), wherein each user device (102) is associated with a user; and
a processing engine (106) configured to cooperate with said user devices (102), said processing engine (106) comprising:
a receiving module (108) configured to receive one or more inputs from said user devices (102);
a validation module (110) configured to cooperate with said receiving module (108), said validation module (110) configured to validate said inputs by using a validation technique;
a database (120) configured to store said validated inputs, pre-defined filters, products related information, and pre-determined rules;
a logic creation module (112) configured to cooperate with said database (120), said logic creation module (112) configured to create a plurality of logics based on said stored data;
an integration module (114) configured to cooperate with said logic creation module (112), said integration module (114) configured to integrate said created logics and generate at least one action; and
a response module (116) configured to cooperate with said integration module (114), said response module (116) configured to generate at least one real-time response based on said generated action and trigger said real-time response on said user devices (102) to provide the real-time product delivery information pertaining to each of the product.

10. The communication system (100) as claimed in claim 9, wherein said logic creation rule is configured to create said logics by performing data mapping on said validated inputs and by defining data variables.

11. The communication system (100) as claimed in claim 9, comprising a scheduler (118) configured to schedule triggering of said generated response on said user devices (102).

12. The communication system (100) as claimed in claim 9, wherein said logic creation module (112) is configured to:
check one or more entities from said stored data;
select at least one entity from the checked entities based on said pre-defined filters;
fetch data for said selected entity and a related entity with associated attributes;
obtain a condition and a value of said fetched data;
match said obtained condition with said pre-determined condition;
provide a filtered data set based on said matched condition; and
generate said logics based on said filtered data set.

13. A computer program product comprising a non-transitory computer-readable storage medium storing a set of instructions, which, when executed by a computing device, cause the computing device to perform the operations of:
receiving one or more inputs from a plurality of user devices (102);
validating said inputs by using a validation technique;
storing said validated inputs, pre-defined filters, products related information, and pre-determined rules;
creating a plurality of logics based on said stored data;
integrating said created logics and generating at least one action;
generating at least one real time response based on said generated action; and
triggering said real-time response on said user devices to provide the real-time product delivery information pertaining to each of the product.

14. The computer program product as claimed in claim 13, comprising a step of creating said logics by performing data mapping on said validated inputs and by defining data variables.

15. The computer program product as claimed in claim 13, comprising a step of triggering said generated response on said user devices (102).

16. The computer program as claimed in claim 13, comprising a step of scheduling trigger of said generated response on said user devices (102).

17. The computer program product as claimed in claim 13, wherein said step of creating the logic comprising:
checking one or more entities from said stored data;
selecting at least one entity from the checked entities based on said pre-defined filters;
fetching data for said selected entity and a related entity with associated attributes;
obtaining a condition and a value of said fetched data;
matching said obtained condition with said pre-determined condition;
providing a filtered data set based on said matched condition; and
generating said logics based on said filtered data set.
